(19) United States
(12) Patent Application Publication
(10) Pub. No.: US 2026/0023515 A1
(43) Pub. Date: Jan. 22, 2026

(54) IMAGE FORMING SYSTEM AND IMAGE FORMING APPARATUS

(71) Applicant: Toshiba Tec Kabushiki Kaisha, Tokyo (JP)

(72) Inventor: Kazuyuki YOSHIKOSHI, Singapore (SG)

(21) Appl. No.: 19/252,658

(22) Filed: Jun. 27, 2025

(30) Foreign Application Priority Data
Jul. 18, 2024 (JP) 2024-114764

(51) Int. Cl. G06F 3/12; B41J 2/325; B41J 3/407

(52) U.S. Cl. CPC G06F 3/1247; B41J 2/325; B41J 3/4075; G06F 3/1211; G06F 3/1251; G06F 3/1293

(57) ABSTRACT

According to an embodiment, an image forming system includes a host computer and an image forming apparatus. The host computer above transmits to the image forming apparatus print information including raster data of an image to be printed by the image forming apparatus and auxiliary data used for print control apparatus. The image forming apparatus holds the raster data included in the print information and controls the driving of the print device based on the raster data and the auxiliary data.

### CROSS-REFERENCE TO RELATED APPLICATIONS

This application is based upon and claims the benefit of priority from the prior Japanese Patent Application No. 2024-114764, filed on Jul. 18, 2024, the entire contents of which are incorporated herein by reference.

### FIELD

An embodiment to be described here generally relates to an image forming system and an image forming apparatus.

### BACKGROUND

One of the image forming apparatuses placed in a workplace is a label printer that prints labels. The label printer in the related art prints label images on print media based on print data configured of a print control language supplied by an external apparatus. The print control language is formulated assuming a traditional and slow communication interface. Therefore, the print data in the print control language can reduce an amount of communication data.

However, the print data in the print control language needs to be converted to image data (raster data) for printing on a printer side. Therefore, the label printer in the related art has a problem that printing capabilities such as a printing speed are determined by a performance in a configuration for converting the print data in the print control language to the raster data. Another problem is that the label printer in the related art needs to save data such as font data that the print control language supports in a flash memory in advance.

### BRIEF DESCRIPTION OF THE DRAWINGS

FIG. 1 is a block diagram showing a configuration example of a host computer in an image forming system according to an embodiment.

FIG. 2 is a block diagram showing a configuration example of a label printer as an image forming apparatus in the image forming system according to the embodiment.

FIG. 3 is a sequence for describing a flow of a print operation in the image forming system according to the embodiment.

FIG. 4 is a diagram showing an example of a drive signal to a mechanical mechanism in the label printer as the image forming apparatus according to the embodiment.

FIG. 5 is a diagram showing an example of a control setting for a slow-up period to start a transport motor in the label printer as the image forming apparatus according to the embodiment.

FIG. 6 is a diagram showing an example of a control setting for a slow-down period to start the transport motor in the label printer as the image forming apparatus according to the embodiment.

FIG. 7 is a diagram showing an example of a setting of the drive signal for a ribbon motor in the label printer as the image forming apparatus according to the embodiment.

FIG. 8 is a diagram showing an example of control information for on/off controlling a ribbon solenoid in the label printer as the image forming apparatus according to the embodiment.

FIG. 9 is a diagram showing an example of a print pattern describing control information of a thermal history to heating elements of the label printer as the image forming apparatus according to the embodiment.

FIG. 10 is a diagram showing an example of a print pattern describing control information of the thermal history to the heating elements of the label printer as the image forming apparatus according to the embodiment.

FIG. 11 is a diagram showing examples of print images printed on label materials as a print medium by the label printer as the image forming apparatus according to an embodiment.

FIG. 12 is a diagram showing a configuration example of print information for an image on each page supplied to the label printer as the image forming apparatus according to the embodiment.

### DETAILED DESCRIPTION

According to an embodiment, an image forming system includes a host computer and an image forming apparatus. The host computer includes a first communication device and a first processor. The first communication device communicates with the image forming apparatus. The first processor generates raster data of an image to be printed by the image forming apparatus. Furthermore, the first processor transmits, via the first communication device, print information including the raster data and auxiliary data used for print control of the image forming apparatus to the image forming apparatus. The image forming apparatus includes a second communication device, a memory, a print device, and a second processor. The second communication device communicates with the host computer. The memory holds the raster data included in the print information from the host computer, which is received by the second communication device. The print device prints an image for each print line. The second processor controls driving of the print device based on the raster data and the auxiliary data.

The label printer as the image forming apparatus according to the embodiment will be described below using the drawings. In the drawings, identical symbols indicate the same or similar parts. However, in the drawings used for the description of the following embodiments, a scale of each part may be changed as necessary. In addition, the drawings used for the description of the following embodiments may show some configurations omitted for the sake of clarity of description.

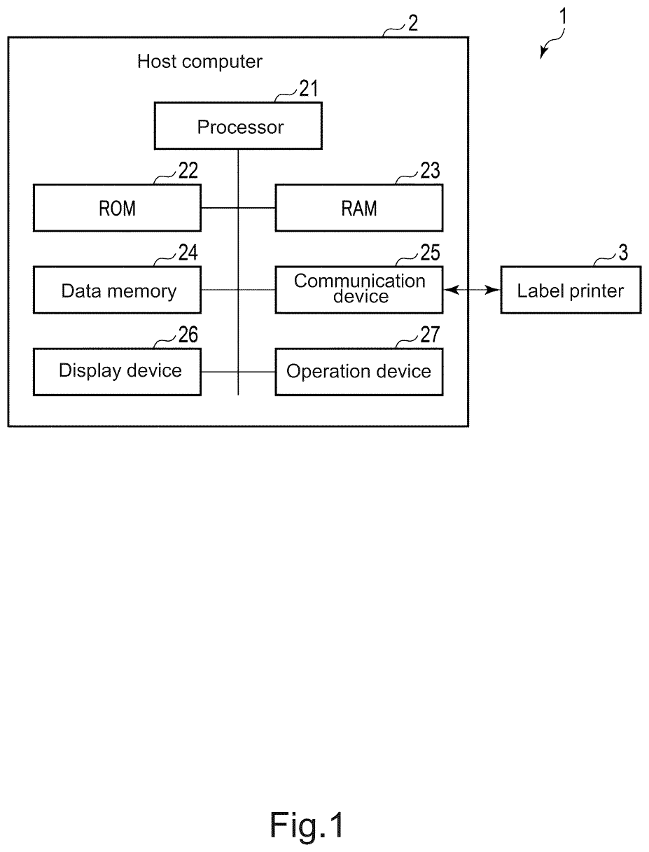

First, a configuration of a label printer 3 in the image forming system according to the embodiment will be described. FIG. 1 is a block diagram showing an image forming system 1 according to the embodiment and a configuration example of a host computer 2 in the image forming system 1. The image forming system 1 includes the host computer 2 and the label printer 3. The image forming system 1 is a system in which label printing instructed by the host computer 2 is executed by the label printer 3. The host computer 2 is connected to the label printer 3 via a communication line. The host computer 2 supplies data for the label printer 3 to print labels.

In the configuration example shown in FIG. 1, the host computer 2 includes a processor 21, a ROM (Read Only Memory) 22, a RAM (Random Access Memory) 23, a data memory 24, a communication device 25, a display device 26, and an operation device 27.

The processor 21 is connected to the ROM 22, the RAM 23, the data memory 24, the communication devices 25, and the display devices 26 via bus lines. The bus lines include address buses, data buses, control signal lines, and the like.

The processor 21 executes various processes of a program. The processor 21 is, for example, a CPU (central processing unit). The processor 21 executes the various processes described below by executing the program stored in the ROM 22 or the data memory 24. For example, the processor 21 executes an operating system (OS) and executes a process by executing an application program operated on the OS.

The ROM 22 is a non-volatile memory. The ROM 22 stores the program and various data to be executed by the processor 21. The RAM 23 is a volatile memory. The RAM 23 is a memory that temporarily holds the data. For example, the RAM 23 operates as an expansion memory that temporarily stores the program and data when the processor 21 executes the program.

The data memory 24 corresponds to an auxiliary storage. The data memory 24 is a rewritable non-volatile memory. The data memory 24 includes, for example, an EEPROM (registered trademark) (Electric Erasable Programmable Read-Only Memory), an HDD (Hard Disc Drive), an SSD (Solid State Drive), and the like. The data memory 24 saves the data used by the processor 21 upon performing the various processes, the data created by the processes of the processor 21, and the like.

The communication device 25 includes a communication interface for communicating with the label printer 3. For example, the communication device 25 is configured of a network interface that communicates with the device via a network.

The display device 26 is configured of a display device that displays information. The display device 26 displays an operation guidance and the like when instructing the label printer 3 to print the labels. The display device 26 may also display information indicating a print status of the label in the label printer 3 and the like.

The operation device 27 is configured of an input device for an operator to input an operation instruction. The input device as the operation device 27 is configured, for example, of a keyboard, a pointing device, a touch panel, and the like. The display device 26 and the operation device 27 may be each configured by a display device with a touch panel.

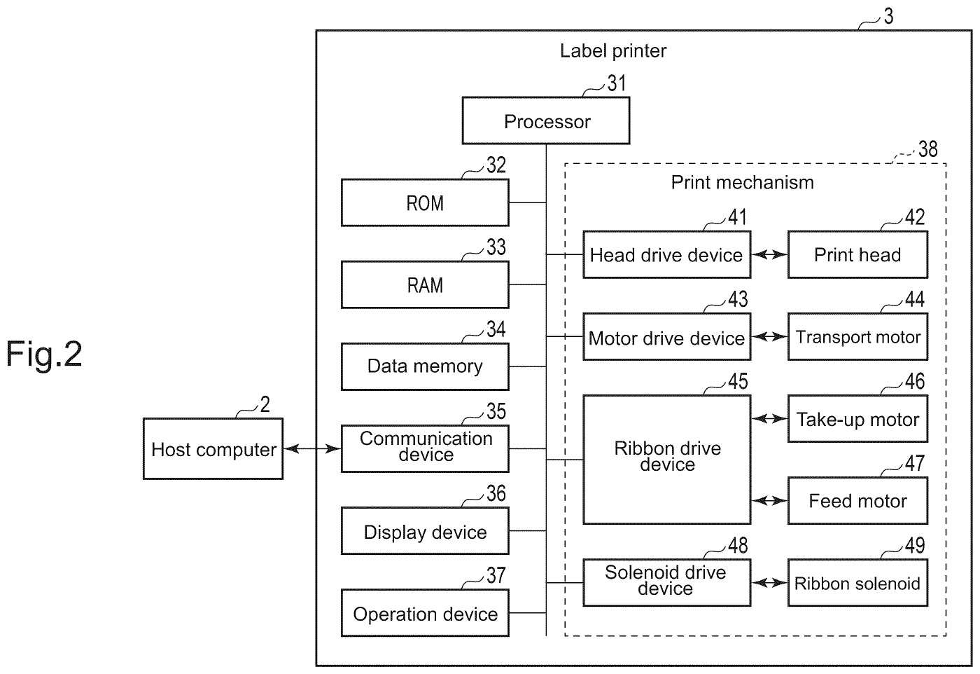

Next, the configuration of the label printer 3 in the image forming system 1 according to the embodiment will be described. FIG. 2 is a block diagram showing a configuration example of the label printer 3 as the image forming apparatus in the image forming system according to the embodiment. The label printer 3 is placed in a workplace. In the configuration example shown in FIG. 2, the label printer 3 includes a processor 31, a ROM 32, a RAM 33, a data memory 34, a communication device 35, a display device 36, an operation device 37, and a print mechanism 38. The print mechanism 38 also includes a head drive device 41, a printhead 42, a motor drive device 43, a transport motor 44, a ribbon drive device 45, a take-up motor (ribbon motor) 46, a feed motor (ribbon motor) 47, a solenoid drive device 48, a ribbon solenoid 49, and the like.

The processor 31 is connected to each part in the label printer 3 via the bus lines including the address buses, the data buses, the control signal lines, and the like. The processor 31 is a processing unit that comprehensively controls the label printer 3. The processor 31 is, for example, the CPU. The processor 31 may also be configured of a plurality of hardware.

The processor 31 may include an MPU (Micro Processing Unit), an SoC (System on a Chip), a DSP (Digital Signal Processor), a GPU (Graphics Processing Unit), an ASIC (Application Specific Integrated Circuit), a PLD (Programmable Logic Device) or an FPGA (Field-Programmable Gate Array), etc. The processor 31 executes a program stored in the ROM 32 or the data memory 34 to perform the processes described below.

The ROM 32 is a non-volatile memory. The ROM 32 stores the program and the various data to be executed by the processor 31. The RAM 33 is a non-volatile memory. The RAM 33 is a memory that temporarily holds the data. The RAM 33 includes a memory (DRAM) that stores the raster data which is the image data for printing (print image) when the printing is executed. In the RAM 33, a memory area is reserved for storing the raster data for one page for printing one label.

The data memory 34 is a rewritable non-volatile memory. The data memory 34 is configured of a flash ROM (flash memory), for example. The data memory 34 stores the data and the like used in performing the various processes. The label printer 3 according to this embodiment is not required to hold font data specified in the print control language by the print operation described below. Also, the label printer 3 according to this embodiment does not require a program for a process of changing the print data in the print control language by the print operation to be described later.

For this reason, the data memory 34 may be sufficient to have a storage capacity to store a minimum amount of data necessary to operate the label printer 3. As a specific example, assume that a printer that executes printing based on the print data in the print control language requires 16 to 128 MB or more of the data memory to store the font data. In contrast, the label printer 3 according to this embodiment can perform an equivalent print operation even with 4 MB of data memory 34.

The communication device 35 is a communication interface for communicating with an external host computer, a user terminal, and the like. For example, the communication device 35 is communicated with/connected to the host computer and receives the print data for the label printing, print commands, and the like supplied by the host computer.

The display device 36 is configured of the display device that displays information. The display device 36 is provided at a position where a display screen is visible to an operator of the label printer 3. The display device 36 displays an operation guidance for the label printer 3 or information indicating a status of the label printer 3. In the label printer 3 according to this embodiment, the processor 31 displays display data supplied from the host computer 2 on the display device 36 as it is.

The operation device 37 is configured of the input device for the operator to input the operation instruction. The input device as the operation device 37 is, for example, various input buttons, a touch panel, or the like. The display device 36 and the operation device 37 may also be each configured of the display device with the touch panel.

The print mechanism 38 prints the print image on the label material as a print medium by heating an ink ribbon by the printhead 42. The processor 31 executes the print operation by controlling each part of the print mechanism 38 in accordance with print control information supplied by the host computer 2.

The head drive device 41 is connected to the printhead 42. The head drive device 41 and the printhead 42 are examples of the print device driven by the drive signal. The head drive device 41 drives the printhead 42. The printhead 42 is provided at a predetermined print position. The printhead 42 includes a plurality of heating elements arranged in the print line in a direction orthogonal to a transport direction of the medium at a print position. The printhead 42 is arranged so that a plurality of the heating elements is in contact with the ink ribbon that is superimposed and transported with the label at the print position. The printhead 42 performs printing on label paper by having the individual heating elements apply heat to the ink ribbon that is transported over the label paper in the print line.

The head drive device 41 generates heat for each heating element configuring the printhead 42 in response to a control instruction of the processor 31. The head drive device 41 controls the heating of each heating element in the printhead 42 in accordance with the raster data and the auxiliary data for each print line in the print image of each page to be printed on the print medium. The printhead 42 heats the ink ribbon that the heated heating elements press against the print medium (label material) at the predetermined print position. As a result, the printhead 42 transfers ink to the print medium in accordance with the image data for each print line.

The motor drive device 43 is connected to the transport motor 44. The motor drive device 43 and the transport motor 44 are examples of a transport device that transports the label material as the print medium. The transport device is one of the mechanical functions (mechanical mechanisms) that operate during the print operation. The motor drive device 43 drives the transport motor 44 in response to the instruction from the processor 31. The transport motor 44 transports the print medium along a predetermined transport path by rotating transport rollers.

In this embodiment, the label printer 3 may print the images on the label material as the print medium. For example, the transport motor 44 transports the label paper in which a plurality of the label materials is arranged on a long strip of backing paper. The label paper includes a plurality of rectangular label materials attached to one side of the long strip of backing paper with a predetermined gap (for example, about 1 to 3 mm) at equal intervals. The label paper is set at a predetermined position in a rolled form.

The ribbon drive device 45 is connected to the take-up motor (ribbon motor) 46 and the feed motor (ribbon motor) 47. The ribbon drive device 45 and ribbon motors 46 and 47 are examples of an ink supply device that supplies the ink ribbon as an image forming material (ink). The ink supply device is one of mechanical functions (mechanical mechanisms) that operate during the print operation.

The ribbon drive device 45 drives the ribbon motors 46 and 47 in response to the instruction from the processor 31. The ribbon motors 46 and 47 transport the ink ribbon so that it overlaps the label paper at the print position. The take-up motor 46 is a motor that rotates the take-up roller. The feed motor 47 is a motor that rotates the feed roller. The ribbon drive device 45 transports the ink ribbon by rotating the feed roller and the take-up roller with the ribbon motors 46 and 47.

For example, the take-up roller takes up the used ink ribbon that has passed the print position into a roll. The feed roller winds the unused long ink ribbon into the roll. The ink ribbon is transported overlapping the label paper through the print position between the feed roller and the take-up roller. The ribbon drive device 45 controls the ribbon motors 46 and 47 so that the ink ribbon is transported in the same direction at the same transport speed as the label paper at the print position. When the feed roller is configured to follow the take-up roller as it rotates, the feed motor 47 may be omitted.

The solenoid drive device 48 drives the ribbon solenoid 49. The solenoid drive device 48 and the ribbon solenoid 49 are examples of an ink suppression device for suppressing the use of the ink ribbon as the image forming material. The ink suppression device is one of the mechanical functions (mechanical mechanisms) that operate during the print operation.

The ribbon solenoid 49 limits the operation of the ribbon motors 46 and 47 to inhibit the use of the ink ribbon. The solenoid drive device 48 can save the use of the ink ribbon by turning on the ribbon solenoid 49 to stop the ribbon motors 46 and 47. The solenoid drive device 48 controls on/off of the ribbon solenoid 49 in response to the instruction from the processor 31.

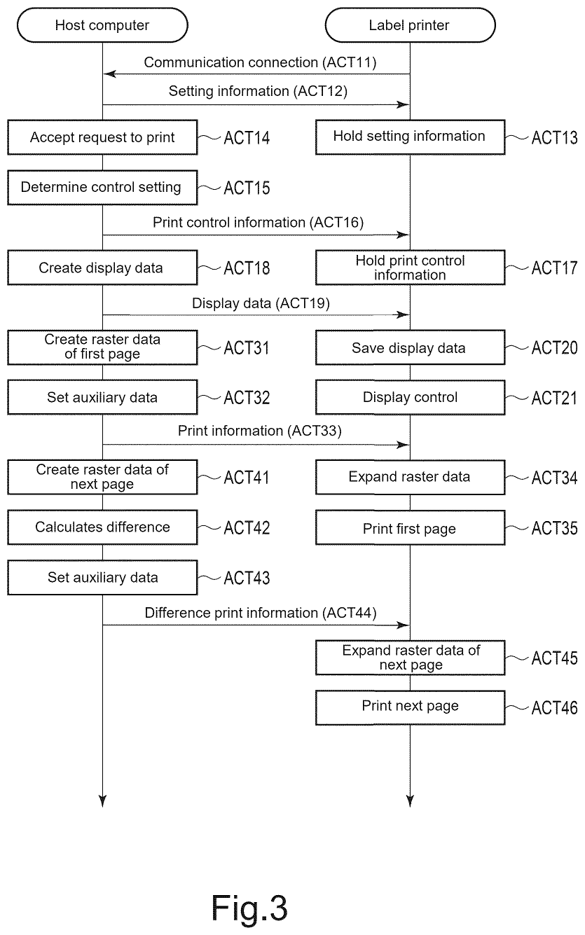

Next, the flow of the print operation in the image forming system 1 according to the embodiment will be described. FIG. 3 is a sequence describing the flow of the print operation in the image forming system 1 according to the embodiment.

First, the image forming system 1 establishes a communication status between the host computer (hereinafter referred to simply as “host”) 2 and the label printer 3 (ACT11) For example, the processor 31 of the label printer 3 requests a communication connection to the host computer 2 by the communication device 35 when the power is turned on or when the operator instructs a start of communication. The host computer 2 receives a connection request from the label printer 3 by the communication device 25. The processor 21 of the host computer 2 establishes the communication connection with the label printer 3 in response to a communication connection request.

The processor 21 of the host computer 2 transmits to the label printer 3 setting information for the label printer 3 communicated and connected (ACT12). For example, the host computer 2 stores the setting information for the label printer 3 in advance in the data memory 24. The processor 21 of the host computer 2 identifies the label printer 3 communicated and connected, and reads out the setting information for the concerned label printer 3 from the data memory 24. The processor 21 transmits the setting information for the concerned label printer 3 read out from the data memory 24 to the label printer 3.

The processor 31 of the label printer 3 saves the setting information received from the host computer 2 in the RAM 33 or the data memory 34 (ACT13). This allows the label printer 3 to operate with the setting information acquired from the host computer 2 when the communication status with the host computer 2 is established.

The host computer 2 accepts a request to print the label by the concerned label printer 3 in a status of being communicated with/connected to the label printer 3 (ACT14). The printing of label by the label printer 3 may be instructed by the host computer 2 or by the label printer 3. For example, when the printing is instructed by the host computer 2, the processor 21 of the host computer 2 identifies the print image (label image) and the printing conditions instructed by the operation device 27. When the printing is instructed by the label printer 3, the processor 21 of the host computer 2 acquires information indicating the print image and information indicating the printing conditions from the label printer 3.

When the processor 21 of the host computer 2 acquires the print image and the printing conditions, it determines the control (operation) setting for each part in the label printer 3 to print the print image on the print medium (ACT15). The processor 21 determines the control setting for operating each mechanical mechanism in the label printer 3 based on the print image and the printing conditions.

As a specific example, the processor 21 determines the control setting for operating the transport motor 44 (transport device) in the label printer 3 based on the print image and the printing conditions. The processor 21 also determines the control setting for operating the ribbon motors 46 and 47 in the label printer 3 based on the print image and the printing conditions. Furthermore, the processor 21 determines the control setting for operating the ribbon solenoid in the label printer 3 based on the print image and the printing conditions.

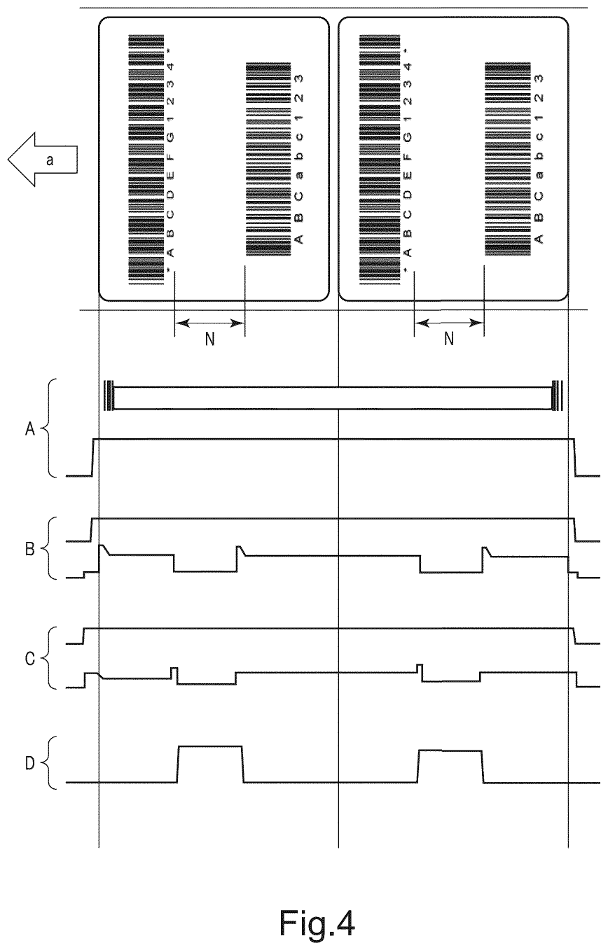

FIG. 4 is a diagram showing examples of the drive signal for each part in the case where the label printer 3 executes the print operation on the print medium (label materials) transported in a transport direction a. The host computer 2 determines the control setting indicating the drive signal for each part in the label printer 3 shown in FIG. 4. The label printer 3 acquires from the host computer 2 the print control information indicating the control setting for the drive signals shown in FIG. 4. As a result, the label printer 3 can operate each part and execute the print operation based on the print control information from the host computer 2 without determining the drive signal for each part by itself.

FIG. 4 shows an example of a drive signal A for the transport motor 44, a drive signal B for the take-up motor 46, a drive signal C for the feed motor 47, and a drive signal D for the ribbon solenoid 49. The drive signal A shown in FIG. 4 is an example of a pulse signal to drive the transport motor 44 and a waveform of the driving current. In FIG. 4, the upper signal of the drive signal A shows the pulse signal given to the transport motor 44, which is a stepping motor, and the lower waveform of the drive signal A shows the waveform of the driving current.

The driving current supplied to the transport motor 44 is a constant driving current during the print operation (medium transport) (period when the transport motor 44 is turned on), as shown in the current waveform of the drive signal A. The pulse signal is set up with a slow-up period, a constant speed period, and a slow-down period. The slow-up period is a period for starting the transport motor 44. The constant speed period is a period for driving the transport motor 44 at a predetermined speed. The slow-down period is a period for starting the transport motor 44.

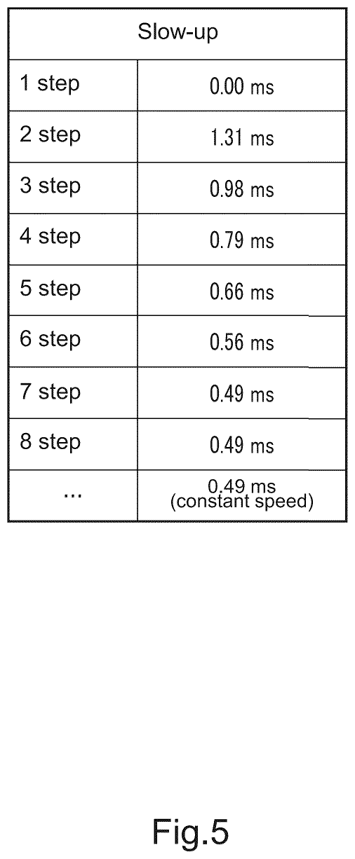

FIG. 5 is a diagram showing an example of the control setting for the slow-up period. According to the setting example shown in FIG. 5, the slow-up period is set for 1 to 8 steps. In the slow-up period, the speed of the transport motor 44 is set to go from 0 to the constant speed in 8 steps.

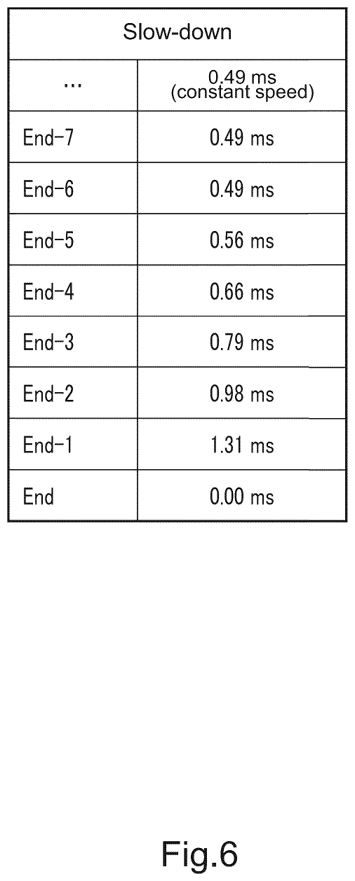

FIG. 6 is a diagram showing an example of the control setting for the slow-down period. In the setting example shown in FIG. 6, the slow-down period is set for end 8 steps before stopping. In the slow-down period, the speed of the transport motor 44 is set to go from the constant speed to 0 in 8 steps.

The host computer 2 holds the setting information for determining the drive signal for the transport motor 44 for each label printer 3 in the data memory 24. With the information stored in the data memory 24, the host computer 2 determines the control setting for the drive signal to operate the transport motor 44 shown in FIG. 4, and supplies it to the label printer 3. This eliminates the need for the label printer 3 to have firmware (program and setting data) to determine the drive signal for the transport motor 44.

The drive signal B shown in FIG. 4 is an example of an on-off signal to drive the take-up motor 46 and the waveforms of the driving current. In FIG. 4, an upper waveform of the drive signal B shows the on/off signal of take-up motor 46, and a lower waveform of the drive signal B shows the driving current of take-up motor 46. The drive signal C shown in FIG. 4 is an example of the on-off signal to drive the feed motor 47 and the waveforms of the driving current. In FIG. 4, an upper waveform of the drive signal C shows the waveform of the on-off signal of the feed motor 47, and a lower waveform of the drive signal B shows the driving current of the feed motor 47.

The on/off signals of the drive signals B and C are turned on during the print operation, similar to the driving current of the transport motor 44. The driving currents of the drive signals B and C each have a waveform that rises at a start of printing, falls in a no-print area N, and rises again at a restart of printing. As a result, the take-up motor 46 and the feed motor 47 are driven at the predetermined speed during the print operation and are controlled to stop or slow down during the period when the print position passes through the no-print area (ink ribbon save period).

In addition, the take-up motor 46 and the feed motor 47 have different driving speeds in accordance with the printing speed and a ribbon diameter of the ink ribbon. Therefore, the driving current that drives the take-up motor 46 and the feed motor 47 has different motor setting values in accordance with the printing speed and ribbon diameter. The host computer 2 supplies the print control information including the drive signals of the take-up motor 46 and the feed motor 47 in accordance with a plurality of ribbon diameters to the label printer 3.

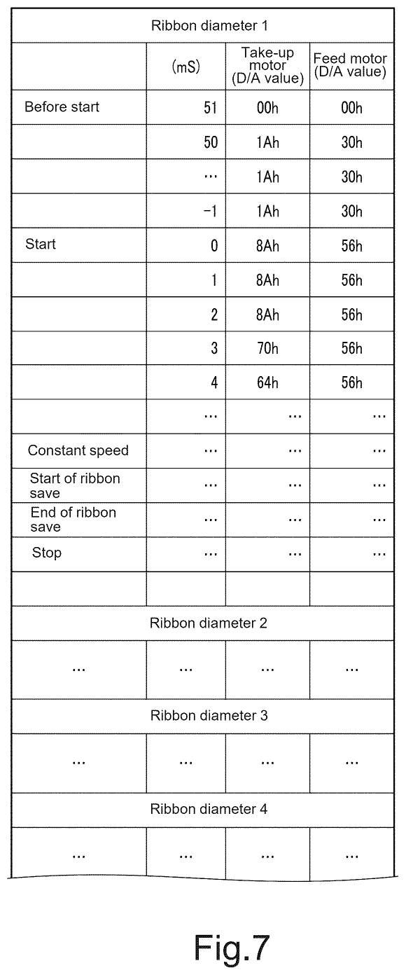

FIG. 7 is a diagram showing an example of the setting information for the drive signals to the take-up motor 46 and the feed motor 47 for each ribbon diameter. In the setting example shown in FIG. 7, digital values (D/A value) supplied to a D/A converter of the ribbon drive device 45 are shown as the setting values of the drive signals to the take-up motor 46 and the feed motor 47. The setting information shown in FIG. 7 specifies the D/A values to be supplied to the take-up motor 46 and the feed motor 47 for each ribbon diameter from before the start to the constant speed after the start.

Furthermore, the setting information shown in FIG. 7 specifies the D/A values to be supplied to the take-up motor 46 and the feed motor 47 for each ribbon diameter during the period from the start to the end of ribbon save. The ribbon save is an operation to reduce consumption of the ink ribbon while the no-print area in the print image passes through the print position. Therefore, the take-up motor 46 and feed motor 47 are supplied with the D/A values set for the period during which the no-print area passes the print position, from the start to the end of the ribbon save.

The host computer 2 holds the setting information for determining the drive signals of the ribbon motors 46 and 47 for each label printer 3 in the data memory 24. The host computer 2 determines the setting information for the drive signals for each ribbon diameter for motors 46 and 47 shown in FIG. 7 by the information stored in data memory 24. The host computer 2 supplies the print control information including the setting information of the drive signals of motors 46 and 47 to the label printer 3.

The label printer 3 drives the motors 46 and 47 at set values in accordance with the ribbon diameter based on the setting information from the host computer 2. This eliminates the need for the label printer 3 to have the firmware (program and setting data) to determine the drive signals for the take-up motor (ribbon motor) 46 and the feed motor (ribbon motor) 47 by the ribbon drive device.

The drive signal D shown in FIG. 4 shows an example of the waveform of the on-off signal to drive the ribbon solenoid 49. The ribbon solenoid 49 is the mechanical mechanism that operates to save the ink ribbon from wear in the no-print area of the print image. The on/off signal of the drive signal D has a waveform that is off in the no-print area N in the print image and on in a predetermined time period before and after the no-print area N. The solenoid drive device 48 drives the ribbon solenoid 49 by the drive signal D. This causes the ribbon solenoid to turn on in the no-print area N to stop the ribbon motors 46 and 47.

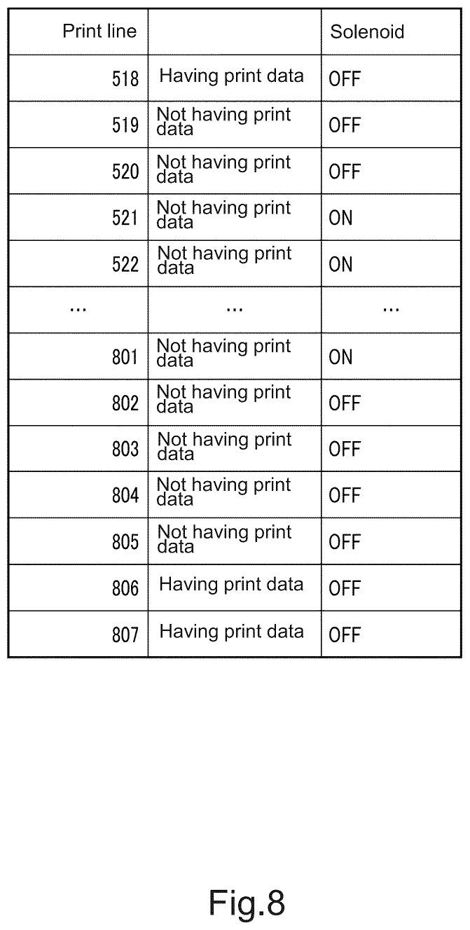

FIG. 8 is a diagram showing an example of control information (on/off information) for controlling the ribbon solenoid 49 on/off. FIG. 8 shows an example of an on/off setting of the ribbon solenoid 49 in accordance with the presence or absence of the print data for each print line that passes through the print position. In the example shown in FIG. 8, the print lines without print data (no-print lines) 519 to 805 correspond to the no-print area in the print image.

In the setting example shown in FIG. 8, the ribbon solenoid 49 is turned on at the print line 521, two lines after the print line 519, where the print data changes from having print data to not having print data. When the ribbon solenoid 49 is turned on, the ribbon motors 46 and 47 are stopped. By turning on the solenoid a few lines after the start of the no-print area (no-print line group), the ribbon motors 46 and 47 can be stopped with a margin of a few lines.

Furthermore, in the setting example shown in FIG. 8, the ribbon solenoid 49 is turned off at the print line (802) four lines before the print line (806) where the print data changes from having print data to not having print data. When the solenoid is turned off, the ribbon motor is re-activated. By turning off the ribbon solenoid 49 a predetermined line before the end of the no-print area (no-print line group), the ribbon motors 46 and 47 can be re-activated so that they are at constant speed for the predetermined line.

As illustrated in FIG. 8, the on/off signal of the solenoid for the ribbon save is information set for each print line. Thus, the on/off signal for the ribbon solenoid 49 is included in the auxiliary data given to each print line in the raster data and is supplied from the host computer 2 to the label printer 3. This allows the label printer 3 to control the on/off of the ribbon solenoid 49 based on the auxiliary data given to each print line of the raster data.

The processor 21 of the host computer 2 identifies the no-print area in the print image and determines the setting information to turn on/off the ribbon solenoid 49 in accordance with the no-print area. The processor 21 of the host computer 2 adds information indicating the on/off of the ribbon solenoid 49 to the auxiliary data given to the raster data. The processor 21 supplies to the label printer 3 the print information including the raster data to which the auxiliary data including the on/off information of the ribbon solenoid 49 is given.

The label printer 3 drives the ribbon solenoid 49 based on the on/off information of the ribbon solenoid 49 included in the auxiliary data of the print information received from the host computer 2. This eliminates the need for the label printer 3 to have firmware (program and setting data) to determine the on/off of the ribbon solenoid 49 by the solenoid drive device 48.

When the processor 21 of the host computer 2 determines the control setting for each part of the label printer 3, it transmits the print control information indicating the determined control setting to the label printer 3 (ACT15). Here, the processor 21 of the host computer 2 may transmit the print setting information to the label printer 3 by data compression or encryption. In this case, the label printer 3 may be provided with a function to decompress the data or decrypt the encrypted data.

When the processor 31 of label printer 3 receives the print control information from the host computer 2, it stores the print control information in the memory such as the RAM 33 (ACT16). The processor 31 of the label printer 3 can execute the print operation in accordance with print contents by operating each part in accordance with the print control information stored in the memory. This allows the label printer 3 to operate each part with the print control information acquired from the host computer 2, without operating each part with the drive signal, etc. calculated by the label printer 3 itself.

When the processor 21 of the host computer 2 determines the control setting for the label printer 3, it also creates the display data to be displayed on the display device 36 of the label printer 3 (ACT17). The processor 21 creates the display data to be displayed on the display device 36 during the print operation by the label printer 3 in accordance with the print contents.

When the processor 21 creates the display data to be displayed on the display device 36, it transmits the created display data to the label printer 3 (ACT18). Here, the processor 21 of the host computer 2 may transmit the display data to the label printer 3 with the data compression or encryption. In this case, the label printer 3 may be provided with the function to decompress the compressed data or decrypt the encrypted data.

When the processor 31 of the label printer 3 receives the display data from the host computer 2, it stores the display data in the memory such as the RAM 33 (ACT19). Once the display data is stored in the memory, the processor 31 of the label printer 3 displays the display screen based on the display data stored in the memory on the display device 36 during the print operation (ACT20).

Note that the host computer 2 may specify to the label printer 3 the display data to be displayed on the display device 36 in accordance with an operating status of the label printer 3. In this case, the label printer 3 may control the display data to be displayed on the display device 36 in response to the instruction from the host computer 2.

The host computer 2 may also acquire information indicating the operating status of the label printer 3 and transmit the display data to the label printer 3 as appropriate in accordance with the operating status. In this case, the label printer 3 may display the received display data on the display device 36 each time it receives the display data from the host computer 2.

The processor 21 of the host computer 2 also generates the print image specified by a print specification. For example, when the label to be printed is specified, the processor 21 identifies the format of the specified label (label format) and acquires the data of each page to be set in each image area of the concerned format. The processor 21 generates the print image for each page by setting the image based on the data for each page in each image area of the label format.

When the processor 21 of the host computer 2 generates the print image, it converts the one-page print image into the image data (raster data, print image data) of a first page for printing (ACT31). The raster data for one page is a data group that arranges data for one page for each line (print line) to be printed by a group of heating elements of the print head 42 of the label printer 3.

When the processor 21 of the host computer 2 generates the raster data of the first page, it sets the auxiliary data to the data for each print line in the raster data (ACT32). The auxiliary data includes the setting information such as the control information for the printhead 42 (head control information) and the control information for the ribbon solenoid (ribbon save setting information) in the label printer 3. The processor 21 of the host computer 2 creates the auxiliary data for each print line of the concerned page based on the print image and the printing conditions.

The control information for the ribbon solenoid is the setting information for turning on/off the ribbon solenoid 49 in accordance with the no-print area in the print image, as described and illustrated in FIG. 8. The head control information includes information about the number of heated dots for the printhead 42 and the control information about the thermal history. The information about the number of heated dots is information for setting the number of dots in accordance with a print density correction. The control information of the thermal history (thermal control parameter) is information for controlling an amount of heat given to the heating elements in accordance with thermal history patterns (past print patterns).

Here, the control information of the thermal history is explained. Each heating element in the printhead 42 is not at a constant temperature, but the temperature fluctuates in accordance with the past print patterns. By controlling a heat generation of the printhead 42 in accordance with the temperature of the heating elements, stable printing can be performed. Thus, the control information of the thermal history sets the amount of heat (for example, controlled by time) to be given to the heating elements that perform printing in accordance with the temperature of the heating elements predicted from the print patterns.

For example, the temperature of the heating elements that continue to be in a no-printing (no-heat generation) status in the print patterns becomes lower. For this reason, when the heating elements that continue the no-printing status perform printing, it is controlled to increase the amount of heat given to the concerned heating elements. On the other hand, the temperature of the heating elements that continue printing in the print patterns becomes high due to a heat storage effect. Thus, when the heating elements performing printing perform printing, the control is performed so that the amount of heat given to the heating elements is lowered. Furthermore, the heating elements are also heated by the heat generated by neighboring heating elements. Therefore, the heat control pattern is determined by taking into account the past print patterns and the print patterns of the neighboring heating elements (history of energization).

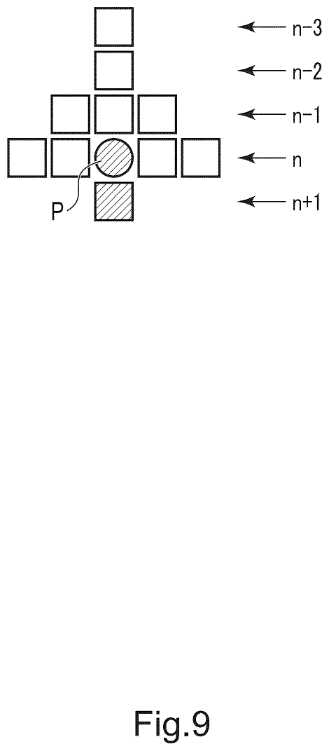

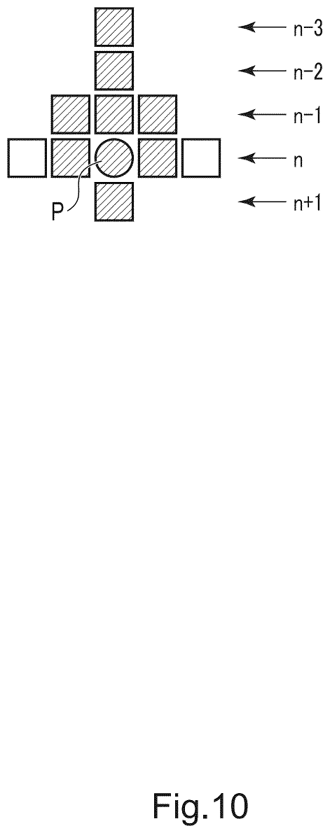

FIG. 9 and FIG. 10 are diagrams showing examples of the print patterns explaining the thermal history to the heating elements. FIGS. 9 and 10 show the print patterns for print lines n−3, n−2, n−1, n, and n+1, with a point P to be printed on the n^{th} line. In the print pattern shown in FIG. 9, the heating elements that print the point P continue no-printing in past print lines before the print line n. The heating elements neighboring the heating elements that print the point P also continue the no-printing. Therefore, the temperature of the heating elements that print the point P on the print line n is low. In response to this, the heating elements may be controlled to increase the amount of heat given when printing the point P of print line n.

In the print pattern shown in FIG. 10, the heating elements that print the point P continue printing in the past print line before the print line n. In addition, the heating elements neighboring the heating element that prints the point P also continue printing. Therefore, the temperature of the heating element that prints the point P on the print line n is high. In response to this, the heating elements may be controlled to lower the amount of heat given to the point P of the print line n.

The processor 21 of the host computer 2 creates the auxiliary data for each print line, including the head control information and the control information for the ribbon solenoid as described above. When the processor 21 of the host computer 2 creates the auxiliary data for each print line, it creates the print information with the auxiliary data set in the raster data for each print line. The processor 21 of the host computer 2 transmits the print information with the auxiliary data given to the data for each print line of the raster data to the label printer 3 (ACT33). For example, the processor 21 of the host computer 2 transmits the print information of the first page for a predetermined number of lines to the label printer 3.

The processor 21 of the host computer 2 may compress or encrypt the data to be transmitted to the label printer 3. For example, the processor 21 of the host computer 2 may compress and transmit the data of the print information to be transmitted to the label printer 3. In this case, the label printer 3 may be provided with the function to decompress the compressed data. This can reduce the amount of communication data of the data (print information) transferred from the host computer 2 to the label printer 3.

The processor 21 of the host computer 2 may also encrypt and transmit the data so that a destination label printer 3 can be decrypted. In this case, the label printer 3 may be provided with a function to decrypt the encrypted data. This allows the host computer 2 to transmit the print information so that a specific destination label printer 3 can be decrypted.

When the processor 31 of the label printer 3 receives the print information from the host computer 2, it expands the raster data included in the received print information into the memory such as the RAM 33 (ACT34). Here, when the processor 31 of the label printer 3 receives the compressed data from the host computer 2, it acquires the print information by decompressing the concerned data. When the processor 31 of the label printer 3 receives the encrypted data from the host computer 2, it acquires the print information by decrypting the concerned data.

When the processor 31 of the label printer 3 expands the raster data of the first page, it starts the print operation of the one page (ACT35). The processor 31 of the label printer 3 operates each part in accordance with the print control information held in the memory to execute printing of the label of the one page based on the raster data of the first page. When the print information is transferred by the predetermined number of lines, the processor 31 of the label printer 3 may start the print operation at the time of storing the raster data for the predetermined number of lines (the number of lines to be able to start printing) is stored in the memory.

The processor 21 of the host computer 2 repeats the transmission of the print information for the predetermined number of lines of ACT33 to the label printer 3 until the transmission of the print information for one page is completed. In this way, the label printer 3 acquires the raster data for one page from the host computer 2.

In addition, following the creation of the one-page print image to the raster data, the processor 21 of the host computer 2 executes a process of converting the print image of a next page into the image data (raster data) of the next page for printing (ACT41). For example, the processor 21 generates the print image of a second page to which the data of the second page is set in each image area of the label format. When the processor 21 generates the two-page print image, it converts the two-page print image into the image data for printing (raster data, print image data).

When the processor 21 of the host computer 2 generates the raster data of the next page, it calculates a difference between the raster data of the next page and the raster data of a previous page (ACT42). For example, the processor 21 detects the difference by multiplying the raster data of the previous-page and the raster data of the next page by XOR (XNOR).

The processor 21 may also detect a different byte block as the difference by extracting a HEX data difference in the raster data. When the HEX data difference is extracted, granularity (for example, 1-bit, 16-bit, etc.) at which the difference is detected between the print image of the previous page and the print image of the next page can be set as appropriate. If there is the difference in the raster data in the print lines, the processor 21 identifies information indicating a start position of the difference. In this way, the processor 21 generates difference data that includes the start position of the difference and the information indicating the difference.

Here, the label printer 3 that prints labels often prints images of labels where only the images of some image areas are changed in a specific label format. In such a printing process, the raster data of the previous page and the raster data of the next page have many areas in common and are often changed only in the images of the some image areas. Thus, when transferring the raster data to the label printer 3, transferring the print information of the next page as the difference data to the previous page is highly effective in reducing the amount of data.

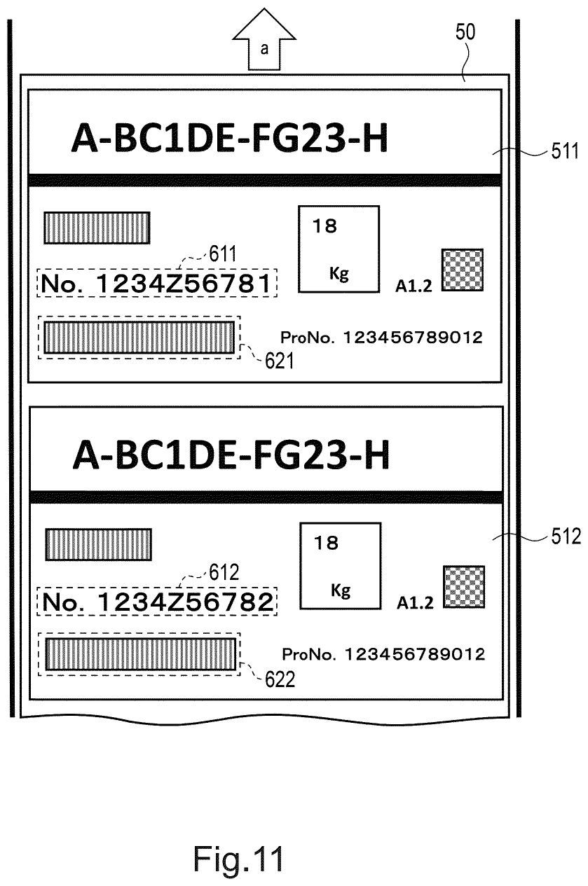

FIG. 11 is a diagram showing examples of the print images (label images) printed on a plurality of the label materials 511, 512 as the print medium arranged on a label paper 50 transported by the label printer 3. As shown in FIG. 11, the label paper 50 has a plurality of label materials 511, 512 arranged at predetermined intervals on a long backing paper and is transported in the transport direction a. The label material 511 is printed with the label image of the first page, and the label material 512 is printed with the label image of the second page. The label image of the first page and the label image of the second page are configured of the same format, and an image in an image area 611 and an image in an image area 621 are different.

In the example shown in FIG. 11, the label image “1234Z56781” in the image area 611 of the first page is changed to the label image “1234Z56782” of the second page. In this case, the difference between the image in the image area 611 and an image in an image area 612 is detected as the difference between the second page raster data with respect to the first page. As the difference data, a difference in the print lines of the image area 612 is calculated. In the image of the image area 611 and the image of the image area 612, “1” is only changed to “2”. Therefore, the start position indicating a print area of “2” in the image area 612 is set to the difference data.

When a barcode of the image area 621 is coded information of “1234Z56781” in the image area 611, the image area 621 and image area 622 are also different images. Such a barcode image in the image area 622 may differ only partially from a barcode image in the image area 621. In this case, the difference between the image in the image area 621 and the image in the image area 622 is detected as the difference between the raster data of the second page and the raster data of the first page. As the difference data, the difference in the print lines of the image area 622 and the start position indicating the print area of a difference image are set.

The processor 21 of the host computer 2 generates the difference data by taking the difference for each print line as described above. When the processor 21 of the host computer 2 generates the difference data, it sets the auxiliary data to the difference data (ACT43). The processor 21 creates the auxiliary data for the print line with difference and sets the auxiliary data to the difference data to generate difference print information. However, when the auxiliary data needs to be changed in the print line before and after the difference data, the processor 21 may add print information to which only the auxiliary data is set.

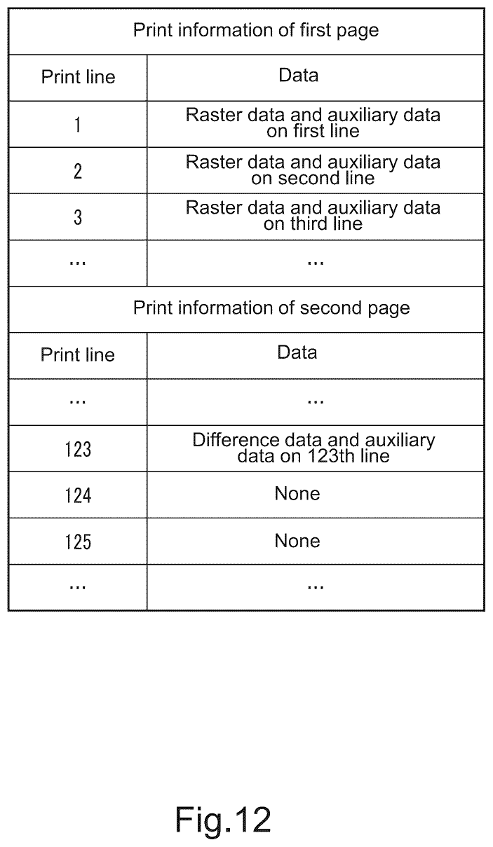

FIG. 12 shows a configuration example of the print information for each page. As shown in FIG. 12, the print information z page is configured of the raster data and the auxiliary data for each print line. In contrast, the print information of the second page (next page) is configured of the difference data and the auxiliary data for each print line that differs from the first page (previous page). As shown in FIG. 12, in the print information of the second page, the print lines that have no difference from the previous page have no data. This means that the print lines with no data in the print information of the second page are the same as the data of the concerned print lines on the previous page.

When the processor 21 of the host computer 2 creates the difference print information with the auxiliary data given to the difference data, it transmits the difference print information to the label printer 3 (ACT44). For example, the processor 21 of the host computer 2 transmits the difference print information to the label printer 3 as the print information of the next page for each predetermined number of lines.

The processor 21 of the host computer 2 may also compress or encrypt the data for the difference print information to be transmitted the label printer 3. In this case, the label printer 3 may be provided with the function to decompress the compressed data and to decrypt the encrypted data.

When the processor 31 of the label printer 3 receives the difference print information as the print information of the next page, it creates the raster data of the next page using the raster data of the previous page and the difference print information (ACT45). The label printer 3 can configure the raster data of the next page by using the raster data of the previous page and the difference data. That is, the label printer 3 can configure the raster data of the next page by updating the raster data of the previous page with the difference data between the previous page and the next page.

For example, the processor 31 copies the raster data of the previous page to the memory area reserved in the RAM 33 or the like for the raster data of the next page. The processor 31 creates the raster data of the next page by updating the raster data of the previous page copied to the memory area for the raster data of the next page with the difference print information.

When the processor 31 of the label printer 3 expands the raster data of the next page into the memory, it executes printing of the next page following the print operation of the previous page (ACT46). The processor 31 of the label printer 3 operates each part in accordance with the print control information held in the memory to execute printing of the label of the next page based on the raster data of the next page.

The processor 21 of the host computer 2 repeats the process of ACTS 41 to 44 until the transmission of the print information for the last page is completed. This allows the label printer 3 to acquire the raster data and auxiliary data for all pages from the host computer 2 and execute printing of all pages.

Although the above-described operation example of the label printer 3 is explained as being carried out by a single processor 31, some or all of the above-described processes may be carried out by an FPGA or an ASIC. By having the FPGA or ASIC carry out some or all of the processes, the printing speed can be increased to a higher speed, thereby the above-described operation can be achieved even if the processes become difficult with a single processor (for example, CPU).

For example, processes of the raster data (e.g., generation of thermal head transfer data for thermal history control), display control of the display device 36, control within each part, and overall control of the print operation may be performed by the FPGA or the ASIC. As a specific example, the processor 21 may focus on data transferring and data processes by information from various sensors (for example, adjustment of amount of heat of thermal head by temperature), and processes by simple data changes (for example, thermal history pattern generation, or communication waveform generation for transferring D/A values to actual D/A converter IC, etc.) may be performed by the FPGA or the ASIC.

In addition, the FPGA can set configuration data as an internal logic as appropriate. That is, the FPGA can flexibly set or change the processes by setting the setting data supplied by the host computer. For example, the FPGA can set to update the print control or change a control timing of each part by the setting data from the host computer. As a specific example, the FPGA can set to update the print control or change the control timing of each part as appropriately by the setting data from the host computer.

As described above, in the image forming system according to the embodiment, the host computer is communicated with/connected to the label printer. The host computer creates the raster data, which is the image data for printing, from the print image to be printed on the print medium by the label printer. The host computer supplies the label printer with the print information, in which the auxiliary data including the control information to be set by the label printer in accordance with the print patterns is given to the raster data. The label printer expands the raster data included in the print information received from the host computer in the memory. The label printer prints the print image on the print medium by operating each part in accordance with the raster data included in the print information and the control information indicated by the auxiliary data.

This allows the label printer to execute printing by the raster data received from the host computer without processing the print data written in the print control language. In addition, the label printer can execute correction control of the print head using the auxiliary data given to the raster data, and can easily set up the correction control without complicated arithmetic processing.

As a result, a label printer configuration can be simplified. Specifically, the data memory (flash memory) of the label printer can be smaller in capacity because it does not need to save a variety of font data and the like. In addition, the data memory of the label printer can have a small memory capacity because it does not need to save the setting data and the like used to control each part. Furthermore, the label printer can have a simplified operating program because no process is needed to determine the drive signals for each part.

In addition, it is possible to improve precision of the print images and the expressiveness of the print images using a variety of fonts, etc., regardless of the configuration of the label printer. Specifically, in addition to the standard fonts of the operating system mounted on the host computer, a variety of fonts that can be installed in the host, such as POP characters, can be easily used. In addition, even the print images edited on the host computer can be supplied to the label printer as the raster data faithfully displayed on the display device of the host computer.

The image forming system according to the embodiment also supplies the control information of the mechanical functions such as the motor drive during the print operation from the host computer to the label printer as the print control information. The label printer controls driving of each part during the print operation based on the print control information from the host computer.

This allows the label printer to drive each part with the print control information from the host computer without determining the drive signals for each part itself. As a result, the label printer does not need to mount or execute a sophisticated program to control the driving of each part, and can have a simple configuration.

When printing a plurality of pages of print images, the host computer according to the embodiment transmits the difference data between the raster data of the previous page and the raster data of the next page as the image data of the next page. The label printer generates the raster data of the next page using the difference data and the raster data of the previous page from the host computer, and executes printing of the next page. This allows the image forming system to reduce the amount of data of the print information including the raster data of the next page or later.

In the image forming system according to the embodiment, the host computer transmits the display data to be displayed on the display device of the label printer to the label printer. The label printer displays the display data received from the host computer on the display device.

This allows the label printer to perform the display control of the display device with the display data from the host computer, without creating the display data to be displayed on its own display device. As a result, the label printer does not need to mount the program or the data to create the display data to be displayed on the display device and can be simply configured.

In the above-described embodiment, the ROM or the data memory of the label printer stores the program for the processor to perform the process or the control described above. To the data memory, which is a writable storage device provided by the label printer, the program that is individually handed over may be written in response to operations by an administrator or the like. The program may also be handed over by storing it on a removable non-transitory tangible computer readable storage medium or by communication via a network. The non-transitory tangible computer-readable storage medium may be an optical disk, a memory card, and the like, as long as it can store program data and is readable by the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming system, comprising:
a host computer; and
an image forming apparatus, and wherein
the host computer includes
a first communication device configured to communicate with the image forming apparatus; and
a first processor configured to
generate raster data of an image to be printed by the image forming apparatus, and
transmit print information including the raster data and auxiliary data used for print control of the image forming apparatus to the image forming apparatus via the first communication device, and
the image forming apparatus includes
a second communication device configured to communicate with the host computer;
a memory configured to hold the raster data included in the print information from the host computer to be received by the second communication device;
a print device configured to print an image for each print line; and
a second processor configured to control driving of the print device based on the raster data and the auxiliary data.

2. The image forming system according to claim 1, wherein
the image forming apparatus further includes a transport device that transports a print medium on which the image is printed by the print device, and
the first processor of the host computer transmits print control information for transporting the print medium using the transport device to the image forming apparatus via the first communication device.

3. The image forming system according to claim 2, wherein
the second processor of the image forming apparatus controls driving of the transport device based on the print control information from the host computer.

4. The image forming system according to claim 1, wherein
when transmitting a plurality of pages of the raster data, the first processor of the host computer transmits difference data between the raster data of a previous page and the raster data of a next page to the image forming apparatus via the first communication device.

5. The image forming system according to claim 4, wherein
when receiving the difference data from the host computer, the second processor of the image forming apparatus creates the raster data of the next page by updating the raster data of the previous page with the difference data.

6. The image forming system according to claim 1, wherein
the image forming apparatus further includes a display device that displays the image by controlling the second processor, and
the first processor of the host computer creates display data, which is image data to be displayed on the display device of the image forming apparatus, and transmits the display data to the image forming apparatus via the first communication device.

7. The image forming system according to claim 6, wherein
the second processor of the image forming apparatus displays the display data received from the host computer on the display device.

8. An image forming apparatus, comprising:
a communication device configured to communicate with a host computer;
a memory configured to hold raster data included in print information received from the host computer by the communication device;
a print device configured to print an image for each print line; and
a processor configured to control driving of the print devices based on the raster data and auxiliary data given to the raster data included in the print information.

9. The image forming apparatus according to claim 8, further comprising a transport device that transports a print medium on which an image is printed by the print device, and wherein
the processor receives print control information for the transport device to transport the print medium from the host computer via the communication device, and controls driving of the transport device based on the print control information.

10. The image forming apparatus according to claim 9, wherein
when receiving difference data between the raster data of a previous page and the raster data of a next page from the host computer via the communication device, the processor creates the raster data of the next page by updating the raster data of the previous page with the difference data.
